(19) United States
(12) Patent Application Publication
(10) Pub. No.: US 2022/0215310 A1
(43) Pub. Date: Jul. 7, 2022

(54) AUTOMATICALLY GENERATING PARAMETERS FOR ENTERPRISE PROGRAMS AND INITIATIVES

(71) Applicant: Ritual Mobile, Inc., Oak Brook, IL (US)

(72) Inventors: Michael Vo, Orange, CA (US); Atif Rafiq, OAK BROOK, IL (US)

(21) Appl. No.: 17/569,874

(22) Filed: Jan. 6, 2022

Related U.S. Application Data
(60) Provisional application No. 63/134,832, filed on Jan. 7, 2021.

(51) Int. Cl. G06Q 10/06; G06K 9/62; G06N 20/00

(52) U.S. Cl. CPC G06Q 10/06311; G06Q 10/06312; G06N 20/00; G06K 9/6256; G06K 9/6262; G06K 9/6248

(57) ABSTRACT

Systems and methods are disclosed herein for automatically generating schemas for enterprise programs and initiatives and generating recommendations for adding parameters to those schemas. The parameters representing tasks, questions, people, milestones, and other suitable parameters to increase the likelihood that an enterprise program or an initiative (sometimes referred to as project) is successful.

### CROSS REFERENCE TO RELATED APPLICATIONS

This application claims the benefit of U.S. Provisional Application No. 63/134,832, filed Jan. 7, 2021, which is incorporated by reference in its entirety.

### TECHNICAL FIELD

The disclosure generally relates to the field of enterprise programs and initiatives.

### BACKGROUND

Enterprise programs and initiatives (sometimes referred to as projects) are an important part of many enterprises. Success of those programs and initiatives may enable enterprises to generate more revenue and/or save on operating expenses. Success or failure of those programs and/or initiatives is based on both the proper execution and on whether the program or the initiative is properly explored to create clarity and strategic alignment amongst team members, stakeholders and personnel. High quality exploration of a program or initiative may include developing a well-defined strategy, identifying strategic issues, exploration of these issues (particularly unknowns), identifying questions as a way to focus exploration, grouping issues into common workstreams, identifying appropriate competencies (skills, roles, personnel) to group around the exploration of issues, and generating appropriate answers to relevant questions. Organizing the aforementioned activities may produce better results by aligning their sequence to important milestones such as decision making, planning, project review and other forums. For example, the output of exploration of a program or initiative may improve the quality and speed of decision making. Alternatively, the output of exploration of a program or initiative may feed into the process of identifying appropriate tasks for execution of the program or initiative. Given the complexity of how these exploration activities are handled, including elements of judgment and need for collective intelligence, automating such activities present numerous technical challenges such as appropriate collaboration paths, workflows and lines of inquiries. Such decision paths often are simply binary with predetermined decision paths. They lack actual decision processing capacity and schemas to be able to continue processing among a wide range of potential subsequent processing directions.

### SUMMARY

Systems and methods are disclosed herein for generating recommendations for adding parameters to those schemas representing, workstreams, issues, unknowns, questions, people, milestones, tasks, and other suitable parameters to ensure that an enterprise program or an initiative (sometimes referred to as project) is successful. To perform these actions, a computing device may receive a first set of parameters of a first type. The first set of parameters may describe a new project. For example, the first set of parameters may include a name, type and issues or questions associated with the project. Based on the received first set of parameters, a new schema for the project is generated.

Moreover, a second set of parameters of a second type is also received. The second set of parameters may correspond to issues that may be encountered during the exploration of the project. Based on the received second set of parameters, the schema for the project is modified. In addition, based on the schema for the project, a first trained model is applied to identify a set of suggested issues for the project (e.g., identify a set of suggested parameters of the second type). The set of suggested issues is presented to a project administrator and a first indication accepting one or more suggested issues is received from the project administrator. Based on the received indication, the schema for the project is modified (e.g., to add parameters of the second type corresponding to the accepted suggested issues).

Furthermore, a third set of parameters of a third type is also received. The third set of parameters may correspond to questions associated with each issue associated with the project. Based on the received third set of parameters, the schema for the project is modified. In addition, based on the schema for the project, a second trained model is applied to identify a set of suggested question for one or more issues associated with the project (e.g., identify a set of suggested parameters of the third type). The set of suggested questions is presented to the project administrator and a second identification accepting one or more suggested questions is received from the project administrator. Based on the received indication, the schema for the project is further modified (e.g., to add parameters of the third type corresponding to the accepted suggested questions).

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1A illustrates an overview block diagram of an example schema for a project, according to one or more embodiments.

FIG. 1B illustrates a hierarchical graph representation of an alternate implementation of an example schema for a project and its associated parameters, according to one or more embodiments.

FIG. 1C illustrates a flat graph representation of an example schema and its associated parameters.

FIG. 2 illustrates a block diagram of a system environment for an example recommendation system, according to one or more embodiments.

FIG. 3 illustrates a block diagram of an architecture of the example recommendation system, according to one or more embodiments.

FIG. 4 illustrates an example process for generating a schema for a new project, according to one or more embodiments.

FIGS. 5A and 5B illustrate an example process 500 for populating the schema of a project, according to one or more embodiments.

FIG. 6A illustrates an example process for recommending parameters for a schema, according to one or more embodiments.

FIG. 6B illustrates an example of one parameter type and possible ratings for various projects for parameters of that type, according to one or more embodiments.

FIG. 6C illustrates an example recommendation interface that enables receiving and updating ratings for various parameters, according to one or more embodiments.

FIG. 7 illustrates an example diagrammatic representation of a machine in the example form of a computer system within which program code (e.g., software) for causing the machine to perform any one or more of the methodologies discussed herein may be executed.

FIG. 8A illustrates a main user interface for a project, according to one or more embodiments.

FIG. 8B illustrates a user interface corresponding to an issue associated with a project, according to one or more embodiments.

FIG. 8C illustrates a user interface for adding members to an issue, according to one or more embodiments.

FIG. 8D illustrates a user interface corresponding to a question associated with an issue of a project, according to one or more embodiments.

FIG. 8E illustrates a user interface for providing feedback about a question-answer pair, according to one or more embodiments.

FIG. 9 illustrates a flow diagram of a process for providing parameters to update a schema for a project, according to one or more embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

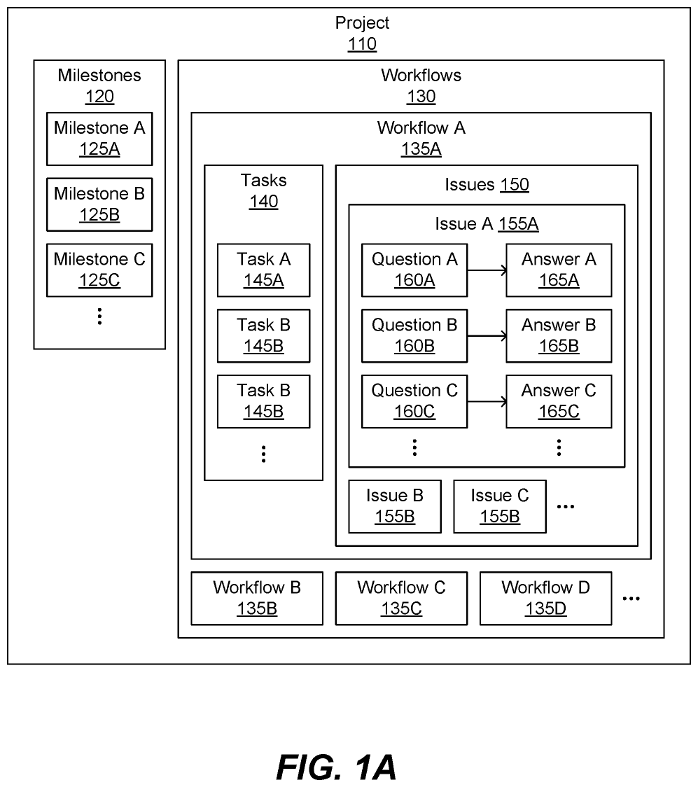

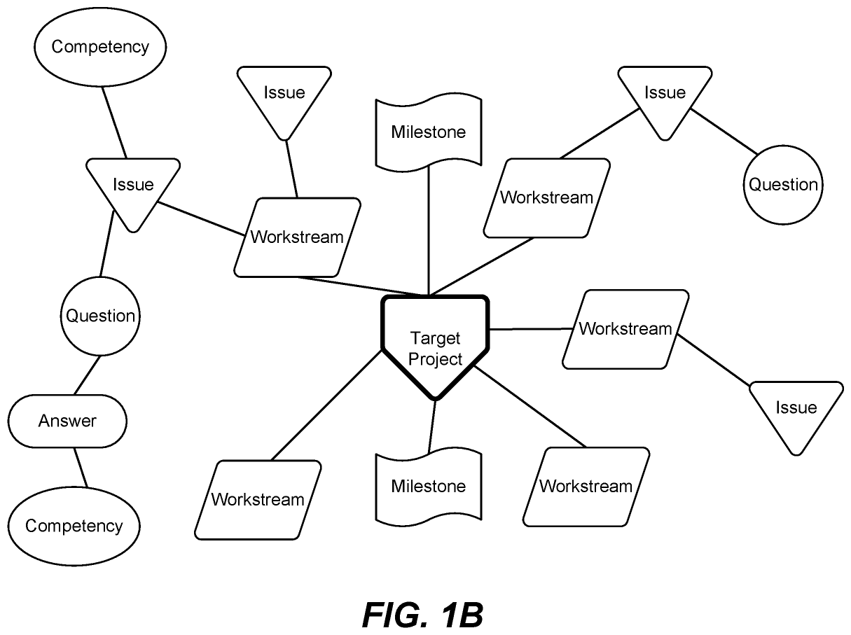

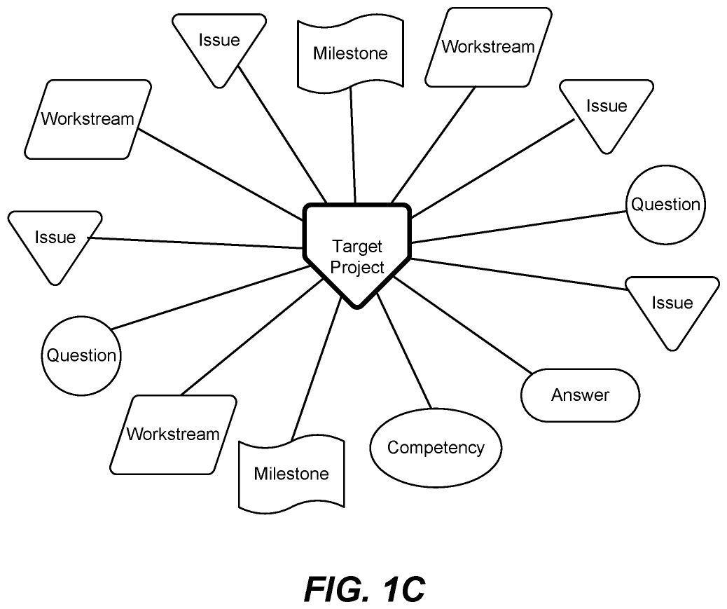

FIG. 1A illustrates an overview block diagram of a schema for a project, according to one or more embodiments. A project 110 includes a set of milestones 120 and a set of workflows 130. In some embodiments, the schema for the project additionally stores information such as a name of the project and a description of the project. Moreover, the project 110 may have a set of users that are assigned to design or execute the project. In some embodiments, general information about a project is provided by a project administrator during an initial schema generation period.

As shown in FIG. 1A, the set of milestones 120 includes multiple milestones 125. For example, the project shown in FIG. 1A includes a first milestone 125A, a second milestone 125B, and a third milestone 125C. Each milestone may store information describing the milestone, a name for the milestone, and a condition for triggering the milestone.

Moreover, the set of workflows include multiple workflows 135. For example, the project shown in FIG. 1A includes a first workflow 135A, a second workflow 135B, a third workflow 135C, and a fourth workflow 135D. Each workflow may store information describing the workflow and a name for the workflow.

Each workflow additionally includes a set of tasks 140. Each task 145 of the set of tasks 140 describes one or more actions to be performed to complete the corresponding workflow 135. Each task may store a description of the task and a name for the task. Each task may further store a set of users assigned to execute the task, and optionally a deadline for completing the task.

Each workflow additionally includes a set of issues 150. Each issue 155 of the set of issues 150 describes a problem that might be encountered during the execution of the workflow. In some embodiments, one or more issues are associated with a task 145 of the set of tasks 140. Each issue may store a description of the issue and a name for the issue. Each issue may additionally store an identification of a set of users that are assigned to providing information for resolving the issue.

In some embodiments, information about issues 155 to be included in the schema for the project 110 is provided by one or more users associated with the project 110 during a sourcing period. In some embodiments, during the sourcing period, each user that is a member of a workflow, task, or project provides information about a set of issues that they think may prevent a task, workflow or project from being completed. In some embodiments, a project administrator may review the information about the different issues provided by users and approves or rejects the issues. In some embodiments, additional issues may be provided after the sourcing period (e.g., as the project, workflow or task is being executed, or during a second sourcing period).

Each issue may additionally include a set of questions 160. Each question 160 of the set of questions may be associated with one or more answers. Each question may contain a string for explaining one or more users assigned to the question (or assigned to the issue associated with the question) for providing information for resolving the issue associated with the question. In some embodiments, each question may additionally store an identification of a set of users that are assigned to answering the question, and optionally a deadline for providing an answer for the question. Moreover, each question may additionally store a priority indication specifying an importance of the question to resolving the issue associated with the question.

A recommendation system also may provide a recommendation for issues to be added to a workflow or project based on information associated with past projects stored by the recommendation system. The recommendation system may provide a set of recommended issues to the project administrator and the project administrator may approve or reject the recommended issues. A description of the recommendation system is provided herein below.

In some embodiments, the questions are provided by users assigned to an issue during a sourcing period (e.g., during the sourcing period when issues are provided, or during a second sourcing period following the sourcing period when issues were provided). In some embodiments, the questions are provided together with information about issues as users are providing the information about the issues during the sourcing period.

Moreover, the recommendation system may provide recommendations for questions to be added to a workflow or issue based on information associated with past projects stored by the recommendation system. The recommendation system may provide a set of recommended questions to the project administrator and the project administrator may approve or reject the recommended question.

Each answer may contain information for addressing an issue. Each answer may be provided by a user assigned to a question or issue associated with the answer. Each answer may contain a string providing the information for resolving the corresponding issue. In some embodiments, each answer may include a complexity score and a usefulness score. The complexity score and the usefulness score may be provided by the project administrator during a feedback period (e.g., after the triggering of a milestone for the project). Alternatively, the complexity score or usefulness score may be provided or computed based on information provided by a user that provided the answer or user that used the answer for addressing the issue during the execution of the project.

FIG. 1B illustrates an example hierarchical graph representation of an alternate implementation of a schema for a project and its associated parameters. In some embodiments, as shown in FIG. 1B, a schema and its parameters can be represented as nodes with a parent/child relationship. For example, the schema for this example project is more tree-like. For example, the target project may connect with one or more workstreams and milestones. Each workstream may connect with one or more issue and teach issue may connect with one or more questions. A question may connect with an answer. Further, FIG. 1C shows a flat graph representation of a schema for a project and its associated parameters. In this example, the target project connects directly with one or more workstreams, milestones, issues, and questions.

### System Architecture

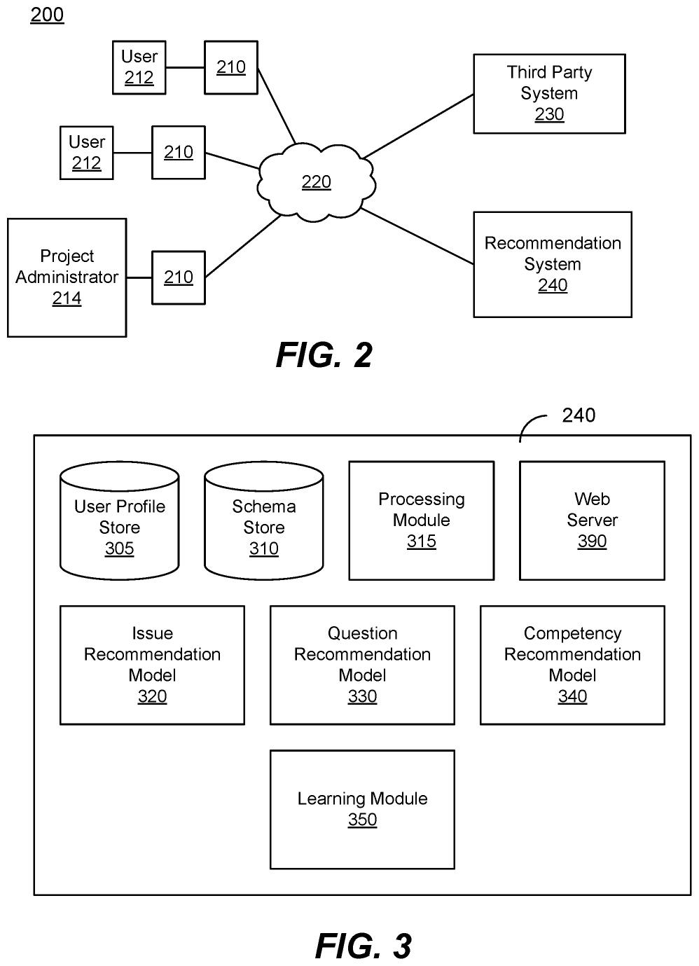

FIG. 2 illustrates a block diagram of a system environment 200 for an example recommendation system 240, according to one or more embodiments. The system environment 200 shown by FIG. 2 comprises one or more client devices 210, a network 220, one or more third-party systems 230, and the recommendation system 240. In alternative configurations, different and/or additional components may be included in the system environment 200.

The client devices 210 are one or more computing devices capable of receiving user input as well as transmitting and/or receiving data via the network 220. In one embodiment, a client device 210 is a conventional computer system, such as a desktop or a laptop computer. Alternatively, a client device 210 may be a device having computer functionality, such as a personal digital assistant (PDA), a mobile telephone, a smartphone, or another suitable device. A client device 210 is configured to communicate via the network 220. In one embodiment, a client device 210 executes an application allowing a user of the client device 210 to interact with the recommendation system 240. For example, a client device 210 executes a browser application to enable interaction between the client device 210 and the recommendation system 240 via the network 220. In another embodiment, a client device 210 interacts with the recommendation system 240 through an application programming interface (API) running on a native operating system of the client device 210, such as IOS® or ANDROID™.

The client devices 210 are configured to communicate via the network 220, which may comprise any combination of local area and/or wide area networks, using both wired and/or wireless communication systems. In one embodiment, the network 220 uses standard communications technologies and/or protocols. For example, the network 220 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 220 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 220 may be represented using any suitable format, such as hypertext markup language (HTML) or extensible markup language (XML). In some embodiments, all or some of the communication links of the network 220 may be encrypted using any suitable technique or techniques.

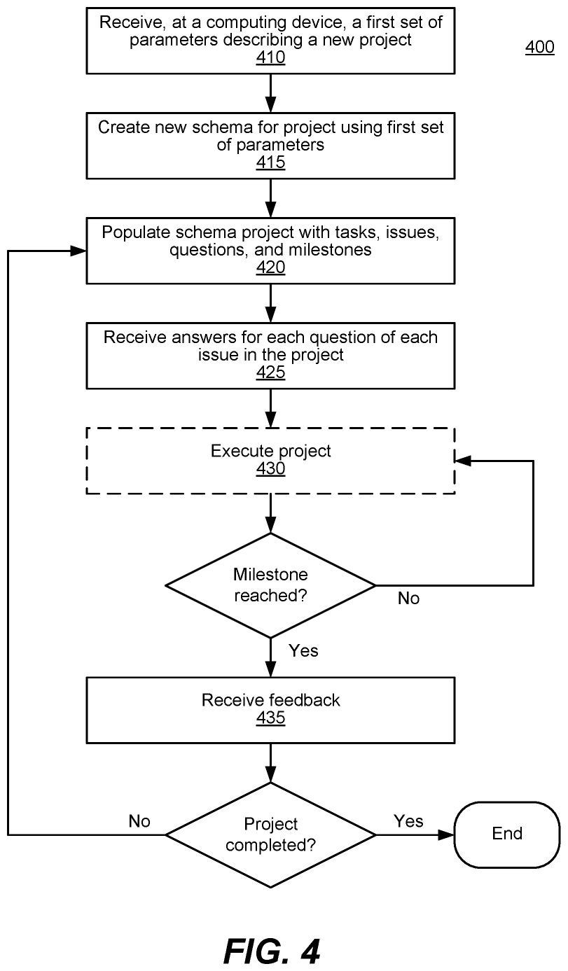

One or more third party systems 230 may be coupled to the network 220 for communicating with the recommendation system 240, which is further described below in conjunction with FIG. 3. In one embodiment, a third party system 230 is an application provider communicating information describing applications for execution by a client device 210 or communicating data to client devices 210 for use by an application executing on the client device. In other embodiments, a third party system 230 provides content or other information for presentation via a client device 210. A third party system 230 may also communicate information to the online system 240, such as information about an application provided by the third party system 230.

FIG. 3 illustrates a block diagram of an architecture of the example recommendation system 240, according to one or more embodiments. The recommendation system 240 shown in FIG. 3 includes a user profile store 305, a schema store 310, a processing module 315, an issue recommendation model 320, a question recommendation model 330, a competency recommendation model 340, a learning module 350, and a web server 390. The profile store 305 and the schema store 310 may be database systems configured as described herein. The processing module 315, web server 390, issue recommendation model 320, question recommendation model 330, and learning module 350 may each be structured as computing components configured to execute program code (e.g., instructions that cause a processor to be a special purpose processor configured for that functionality) as described herein. In other embodiments, the recommendation system 240 may include additional, fewer, or different components for various applications. Conventional components such as network interfaces, security functions, load balancers, failover servers, management and network operations consoles, and the like are not shown so as to not obscure the details of the system architecture.

Each user of the recommendation system 240 is associated with a user profile, which is stored in the user profile store 305. A user profile includes declarative information about the user that was explicitly shared by the user and may also include profile information inferred by the recommendation system 240. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos.

The schema store 310 stores schemas generated for each project processed by the recommendation system 240. Each schema stores a set of parameters. For example, each schema may store parameters of a first type providing a general description of the project, parameters of a second type corresponding to issues associated with the project, parameters of a third type corresponding to questions associated with an issue of the project, and parameters of a fourth type corresponding to answers to a question associated with the project.

The processing module 315 receives a set of parameters and creates or updates schemas based on the received set of parameters. In some embodiments, the processing module 315 receives a first set of parameters of a first type and creates a new schema based on the second set of parameters. The parameters of the first type may include information describing a new project. In some embodiments the processing module 315 receives the first set of parameters of the first type from a client device 210 of a project administrator.

In some embodiments, the parameters of the first type include a name of the project. Additionally, the parameters of the first type may include a description of the project. The parameters of the first type may also include an identification of the user (such as the project administrator) providing the parameters of the first type for creating a new schema for a new project.

The processing module 315 may additionally receive a second set of parameters of a second type and updates the schema based on the second set of parameters. The second set of parameters may include information describing a set of issues associated with the project. In some embodiments, the processing module 315 receives at least a subset of the second set of parameters from the client device 210 of the project administrator. Additionally, in some embodiments, the project administrator may assign a set of users to the project. Each of the assigned users may also provide information describing one or more issues associated with the project.

In some embodiments, the parameters of the second type include a string with a description of an issue associated with the project. Moreover, the parameters of the second type may include a name for the issue associated with the project. In some embodiments, the parameters of the second type may additionally include an identification of the project associated with the issue. Moreover, the parameters of the second type may include an identification of the user that provided the issue.

The processing module 315 may aggregate the information describing issues received from each of the users assigned to the project and may present the issues to the project administrator. The project administrator may review the issues and may provide an indication to either add the issue to the project or to exclude the issue from the project. Upon receiving an indication to add an issue to the project, the processing module 315 automatically modifies the schema for the project.

In some embodiments, the processing module 315 applies a trained model to determine a likelihood score that parameters of the second type describing a first issue and parameters of the second type describing a second issue should be grouped together as corresponding to the same issue. The processing module 315 may compare the likelihood score to a threshold value and may aggregate the first issue and the second issue if the likelihood score is higher than the threshold value.

In some embodiments, the likelihood score is determined based on the description of the first issue and the description of the second issue. Moreover, in some embodiments, the processing module 315 first normalizes the description of the first issue and the description of the second issue before applying the trained model to determine whether to aggregate the first issue and the second issue as corresponding to the same issue. In some embodiments, the processing module 315 calculates a first embedding vector for the description of the first issue, and a second embedding vector for the description of the second issue and applies the trained model based on the embedding vector for the first issue and the embedding vector for the second issue. For instance, the embedding vector for each of the issues may be determined by determining a word embedding for each word included in the description of the issue (or included in the normalized version of the description of the issue), and combining the word embeddings into an issue embedding vector. The trained model may further calculate the likelihood score that the first issue and the second issue correspond to the same issue based on the distance between the embedding vector for the first issue and the embedding vector of the second issue.

Alternatively, or in addition, the processing module 315 compare the description of the first issue and the description of the second issue and determines a similarity score between the description of the first issue and the description of the second issue. If the similarity score is higher than a threshold value, the processing module 315 determines that the first issue and the second issue correspond to the same issue and aggregate the first issue and the second issue.

In some embodiments, the processing module 315 ranks the issues and presents the issues to the project administrator sorted based on the ranking. For example, the processing module 315 determines a score for each issue and presents the issues to the project administrator sorted in descending order based on the score. Moreover, the processing module 315 may filter the set of issues based on the determined score. For example, the processing module may present a top set of issues (e.g., to 20 issues). The score for the issue may be determines at least in part based on a number of users that provided the issue to the recommendation system. That is, based on the number of issues provided by different users that were aggregated together as corresponding to the same issue. Alternatively, or in addition, the score is determined by applying a model trained using issues that were included in previous projects (e.g., completed projects).

The processing module 315 may also receive a third set of parameters of a third type and updates the schema based on the third set of parameters. The third set of parameters may include information describing a set of questions for each issue associated with the project. In some embodiments, the processing module 315 receives at least a subset of the third set of parameters from the client device 210 of the project administrator. Additionally, in some embodiments, the project administrator may assign one or more users to each of the issues associated with the project. Each user associated with a project may then provide information describing one or more questions for their corresponding issues.

In some embodiments, the parameters of the third type include a string with a question associated with an issue of a project. The parameters of the third type may additionally include an identification of the issue and/or project associated with the question. Moreover, the parameters of the third type may include an identification of the user that provided the question.

In some embodiments, the processing module 315 may aggregate the information describing multiple questions and may present the questions to the project administrator. The project administrator may review the questions for each issue and may provide an indication to either add the question to a corresponding issue, or to exclude the question. Upon receiving an indication to add a question to an issue, the processing module 315 automatically modifies the schema for the project accordingly. Moreover, the project administrator may provide feedback related to the answer. For example, the project administrator may provide a complexity and/or quality rating for the answer. In some embodiments, the complexity and quality rating for the answer may be stored in by the recommendation system 240 and may be used for training the various recommendation models.

In some embodiments, the processing module 315 applies a trained model to determine a likelihood score that parameters of the third type describing a first question and parameters of the third type describing a second question should be grouped together as corresponding to the same question. The processing module 315 may compare the likelihood score to a threshold value and may aggregate the first question and the second question if the likelihood score is higher than the threshold value.

In some embodiments, the likelihood score is determined based on the string corresponding to the first question and the string corresponding to the second question. Moreover, in some embodiments, the processing module 315 first normalizes the de string corresponding to the first question and the string corresponding to the second question before applying the trained model to determine whether to aggregate the first questions and the second question as corresponding to the same question. In some embodiments, the processing module 315 calculates a first embedding vector for the string corresponding to the first question, and a second embedding vector for the string corresponding to the second question and applies the trained model based on the embedding vector for the first question and the embedding vector for the second question. For instance, the embedding vector for each of the issues may be determined by determining a word embedding for each word included in the string of the question (or included in the normalized version of the string of the question), and combining the word embeddings into a question embedding vector. The trained model may further calculate the likelihood score that the first question and the second question correspond to the same question based on the distance between the embedding vector for the first question and the embedding vector of the second question.

Alternatively, or in addition, the processing module 315 compare the string corresponding to the first question and the string corresponding to the second question and determines a similarity score between the string corresponding to the first question and the string corresponding to the second question. If the similarity score is higher than a threshold value, the processing module 315 determines that the first question and the second question correspond to the same question and aggregate the first question and the second question.

In some embodiments, the processing module 315 ranks the question and presents the questions to the project administrator sorted based on the ranking. For example, the processing module 315 determines a score for each question and presents the questions to the project administrator sorted in descending order based on the score. Moreover, the processing module 315 may filter the set of questions based on the determined score. The score for the question may be determines at least in part based on a number of users that provided the question to the recommendation system. That is, based on the number of questions provided by different users that were aggregated together as corresponding to the same question. Alternatively, or in addition, the score is determined by applying a model trained using questions that were included in an issue of a previous projects (e.g., completed projects).

In some embodiments, a project administrator additionally provides an identification of one or more users to assign to a question. After the question is added to the issue, the users assigned to the questions may be notified to provide an answer for the question. In some embodiments, the user interface of a user is generated to provide a user interface element to allow the user to provide answers to questions the user is assigned to.

The processing module 315 additionally receives a fourth set of parameters of a fourth type and updates the schema based on the fourth set of parameters. The fourth set of parameters may include information corresponding to answers for questions associated with issues of the project. In some embodiments, for each question of a project, the processing module 315 receives parameters of the fourth type corresponding to an answer for the question from one or more users assigned to the question.

In some embodiments, the parameters of the fourth type include a string corresponding to an answer provided for a corresponding question. Moreover, the parameters of the fourth type include an identification of the question associated with the answer. Additionally, the parameters of the fourth type may include an identification of the user that provided the answer.

In some embodiments, the processing module 315 generates the answers to provide for display to a project administrator and may receive feedback for each of the answers from the project administrator. The project administrator may provide an indication whether to accept or reject the answer. Moreover, the project administrator may provide a comment for an answer or may request a user that provided an answer to revise the answer.

In addition, the processing module 315 may apply a trained model to determine a quality score for each answer received by the processing module 315. The trained model for determining a quality score for answers may be trained based on past answers provided for other projects. Moreover, the model for determining a quality score for answers may be trained based on feedback or comments provided for the past answers, and optionally based on whether the issue or project associated with the past answer was successful.

In some embodiments, the processing module 315 identifies whether a milestone has been reached for a project. In response to determining that a milestone was reached, the processing module 315 may request one or more users (such as the project administrator 214 for the project or other users associated with the project) for feedback regarding one or more issues, questions, and/or answers associated with the project.

The issue recommendation model 320 receives as an input information corresponding to a target project 110 and outputs a set of recommended issues 255 to be added to the target project. In one embodiment, the issue recommendation model 320 receives as an input, one or more feature vectors generated based on information corresponding to the target project. The one or more feature vectors may be generated based on at least a subset of the parameters of the first type (corresponding to a description of the target project), and a subset of the parameters of the second type (corresponding to descriptions of one or more issues associated with the target project). Moreover, in some embodiments, the one or more feature vectors generated for using with the issue recommendation model 320 are generated based on the indication provided by a project administrator to either include or exclude the issues from the target project.

In some embodiments, for each issue of a set of issues, the issue recommendation model 320 generates an issue recommendation score based on the feature vectors provided as an input. For a given issue associated with a past project, the issue recommendation model may determine the issue recommendation score for the given issue based on a similarity between a description of the past project and the description of the target project. Moreover, the issue recommendation model 320 determines the issue recommendation score for the given issue based on an overlap between the issues associated with the past project and the issues associated with the target project.

In some embodiments, the issue recommendation model 320 is trained based on schemas of other projects stored in the schema store 310. In some embodiments, the training data for training the issue recommendation model 320 includes a set of issues that were included in a past projects. The training data may additionally specify whether the issue was resolved successfully in the past project or whether the project associated with the issue was completed successfully. In some embodiments, a feature vector is generated for each issue in the training data set. The feature vector may be generated based on information corresponding to the issue (e.g., parameters of the second type for the issue). In addition, the feature vector for the issue may be generated based on information corresponding to the past project associated with the issue. For example, the feature vector for the issue may be generated based parameters of the first type corresponding to the past project associated with the issue. Moreover, the feature vector for the issue may be generated based on information corresponding to other issues associated with the past project (e.g., parameters of the second type corresponding to other issues associated with the past project).

The question recommendation model 330 receives as an input information corresponding to a target project 110 and outputs a set of recommended questions for one or more issues associated with the target project. In some embodiments, the question recommendation model 330 receives as an input, one or more feature vectors generated based on information corresponding to the target project. The one or more feature vectors may be generated based on at least subset of the parameters of the first type (corresponding to a description of the target project), a subset of the parameters of the second type (corresponding to descriptions of one or more issues associated with the target project), and a subset of the parameters of the third type (corresponding to one or more questions for issues associated with the target project). Moreover, in some embodiments, the one or more feature vectors generated for using with the question recommendation model 330 are generated based on the indication provided by a project administrator to either include or exclude a question for an issue associated with the target project.

In some embodiments, for each question of a set of questions, the question recommendation model 330 generates a question recommendation score based on the feature vectors provided as an input. In some embodiments, the question recommendation model 330 generates question recommendation scores for a first set of questions based on a similarity between the issues associated with each question of the first set of questions and a first issue of the target project. Moreover, the question recommendation model 330 generates question recommendation scores for a second set of questions based on a similarity between the issues associated with each question of the second set of questions and a second issue of the target project. This process may be repeated for each issue of the target project.

In some embodiments, the question recommendation model 330 is trained based on schemas of other projects stored in the schema store 310. In some embodiments, the training data for training the question recommendation model 330 includes a set of questions that were included in issues of past projects. The training data may additionally specify whether the question was helpful for resolving the issue or whether the project associated with the question was completed successfully. In some embodiments, a feature vector is generated for each question in the training data set. The feature vector may be generated based on information corresponding to the question (e.g., parameters of the third type for the question). In addition, the feature vector for the question may be generated based on information corresponding to the issue associated with the question, and information corresponding to the past project associated with the question. For example, the feature vector may be generated based on parameters of the second type corresponding to the issue associated with the question, and parameters of the first type corresponding to the past project associated with the question. Moreover, the feature vector for the question may be generated based on information corresponding to other issues associated with the past project, and information corresponding to other questions associated with the issue.

The competency recommendation model 340 receives as an input information corresponding to a target project 110 and outputs a set of recommended competencies for one or more workflows, one or more issues, one or more questions, or one or more tasks. In some embodiments, the competency recommendation model 340 selects recommended competencies based on the one or more workflows, one or more issues, one or more questions, or one or more tasks the recommendation is being made for. That is, for example, when generating a recommendation for an issue, the competency recommendation model 340 selects the recommended competency based on information about the issue. Moreover, the competency recommendation model may generate the recommended competency based on the workflow the issue is associated with, and optionally based on the entire schema for the project. In another example, when generating a competency recommendation for a question, the competency recommendation model 340 selects the recommended competency based on information about the question. In addition, the competency recommendation model may generate the recommended competency based on the issue the question is associated with, the workflow that issue is associated with, and/or optionally based on the entire schema for the project.

In some embodiments, the competency recommendation model 340 receives as an input, one or more feature vectors generated based on information corresponding to a question, an issue, a workflow, and/or the target project. The one or more feature vectors may be generated based on at least subset of the parameters of the first type (corresponding to a description of the target project), a subset of the parameters of the second type (corresponding to descriptions of one or more issues associated with the target project), and a subset of the parameters of the third type (corresponding to one or more questions for issues associated with the target project). In some embodiments, for each competency of a set of competencies, the competency recommendation model 340 generates a competency recommendation score based on the feature vectors provided as an input.

In some embodiments, the competency recommendation model 340 is trained based on schemas of other projects stored in the schema store 310. In some embodiments, the training data for training the competency recommendation model 340 includes a set of competencies that were included in issues or questions of past projects. The training data may additionally specify whether the competency was helpful for resolving the issue or answering the question or whether the project associated with the issue or question was completed successfully. In some embodiments, a feature vector is generated for each competency in the training data set. The feature vector may be generated based on information corresponding to the competency. In addition or alternatively, the feature vector for the competency may be generated based on information corresponding to the issue or question associated with the competency, and information corresponding to the past project associated with the issue or question.

The learning module 350 applies machine learning techniques to generate the issue recommendation model 320 and the question recommendation model 330. As part of the generation of the issue recommendation model 320 and the question recommendation model 330, the learning module 350 generates one or more training sets. For example, the learning module 350 may generate a first training for training the issue recommendation model 320 and a second training set for training the question recommendation model 330. The first training set for training the issue recommendation model 320 includes a set of issues that were included in past projects stored in the schema store 310. The second training set for training the question recommendation model 330 includes a set of questions that were included in issues of past projects stored in the schema store 310.

In some embodiments, the learning module 350 uses supervised machine learning to train the issue recommendation model 320 and the question recommendation model 330, with the feature vectors of the training sets serving as the inputs. Different machine learning techniques—such as linear support vector machine (linear SVM), boosting for other algorithms (e.g., AdaBoost), neural networks, logistic regression, naïve Bayes, memory-based learning, random forests, bagged trees, decision trees, boosted trees, or boosted stumps—may be used in different embodiments.

The web server 390 links the online system 240 via the network 220 to the one or more client devices 210, as well as to the one or more third party systems 230. The web server 390 serves web pages, as well as other content, such as JAVA®, FLASH®, XML and so forth. The web server 390 may receive and route messages between the online system 240 and the client device 210, for example, instant messages, queued messages (e.g., email), text messages, short message service (SMS) messages, or messages sent using any other suitable messaging technique. A user may send a request to the web server 390 to upload information (e.g., images or videos) that are stored in the content store 310. Additionally, the web server 390 may provide application programming interface (API) functionality to send data directly to native client device operating systems, such as IOS®, ANDROID™, or BlackberryOS.

### Sample Recommendation Process

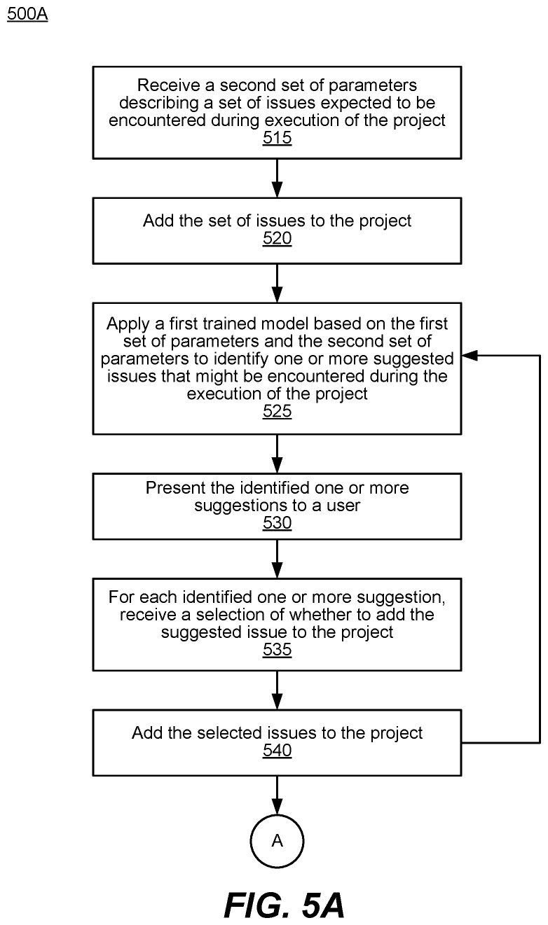

FIG. 4 illustrates an example process for generating a schema for a new project, according to one or more embodiments. In some embodiments, the steps shown in FIG. 4 are performed by the recommendation system 240. Alternatively, one or more steps of the process 400 are performed by one or more other systems (such as the third party system 230 or a client device 210). It should be noted that in some embodiments, the process 400 illustrated in FIG. 4 can include fewer, additional, or different steps than those described herein. Moreover, the steps of process 400 may be performed in a different order than the one shown in FIG. 4.

The recommendation system receives 410 a first set of parameters of a first type describing a new project. Using the first set of parameters of the first type, the processing module 315 of the recommendation system 240 creates 415 a new schema for the project. Moreover, during a sourcing period, the recommendation system 240 receives information about milestones, workflows, tasks, issues, and questions for the new project, and automatically populates 420 the schema for the project based on the received information. In some embodiments, a separate sourcing period is run for receiving milestones, workflows, tasks, issues, and/or questions. For example, for each workflow, a separate issue sourcing period is run to receive information about issues to be associated with the workflow. Similarly, for each issue, a separate question sourcing period is run to receive information about questions to be associated with the issue.

In some embodiments, the information about milestones, workflows, tasks, issues, and questions for the new project is received from a project administrator of the new project. Alternatively, or in addition, the information about milestones, workflows, tasks, issues, and questions for the new project is received from users assigned to the new project. In some embodiments, the information about milestones, workflows, tasks, issues, and questions received from users other than the project administrator is sent to the project administrator for approval prior to being used to populate the schema for the new project. Moreover, in some embodiments, during the sourcing period, information received from each of the users is hidden from other users assigned to the project. For example, during a sourcing period for issues, the issues received from one user is hidden from (i.e., not presented to) other users assigned to the project. Similarly, during a sourcing period for questions, the questions received from one user is hidden from other users assigned to the project or issue for which the questions are being sourced.

In some embodiments, the recommendation system 240 additionally applies recommendation models (such as the issue recommendation model 320 and the question recommendation model 330) to recommend issues or questions for the new project. In some embodiments, the recommendation models are executed using information included in the schema of the project populated based on information about milestones, workflows, tasks, issues, and questions received from the project administrator and other users assigned to the project. The recommended issues and questions are sent to the project administrator or approve or reject the suggestions. The recommendation system 240 may then automatically populate the schema for the new project based on the recommended issues and questions approved by the project administrator.

The recommendation system 240 receives answers for each of the questions included in schema of the new project. Each of the questions may be provided to one or more users assigned to the question or assigned to an issue associated with the question. The received answers are then sent to the project administrator. The project administrator may accept the answer, reject the answer, and/or provide feedback for the answer.

After the schema for the project has been created, the project may be executed 430. As the project is being executed, the project workers may review the issues and questions included in the schema for the project for information that is useful or helpful for the execution of the project. The recommendation system may then periodically or upon the occurrence of a certain event, determine whether a milestone of the project has been reached. If a milestone has not been reached, the execution of the project continues. However, if a milestone has been reached, the recommendation system requests feedback from one or more users (e.g., the project administrator or workers executing the project). The recommendation system receives 435 the feedback and optionally modifies the schema for the project based on the feedback. Moreover, the recommendation system 240 may retrain the issue recommendation model 320 or the question recommendation model 330 based on the received feedback.

In some embodiments, the recommendation system 240 determines whether the project has been completed. If the project has not yet been completed, the process may loop back to step 420. That is, the recommendation system may allow users to provide additional information about milestones, workflows, tasks, issues or questions, and/or may apply a recommendation model to recommend issues or questions based on the received feedback. The recommendation system may then automatically modify or further populate the schema for the project based on the received information or approved recommendations.

In some embodiments, if the recommendation system 240 determines that the project has been completed, the recommendation system 240 retrains the issue recommendation model 320 or the question recommendation model 330 based on whether the project was successful. For example, the recommendation system 240 may request feedback about the completion of the project and may label the training data for the issue recommendation model 320 or the question recommendation model 330 based on the received feedback.

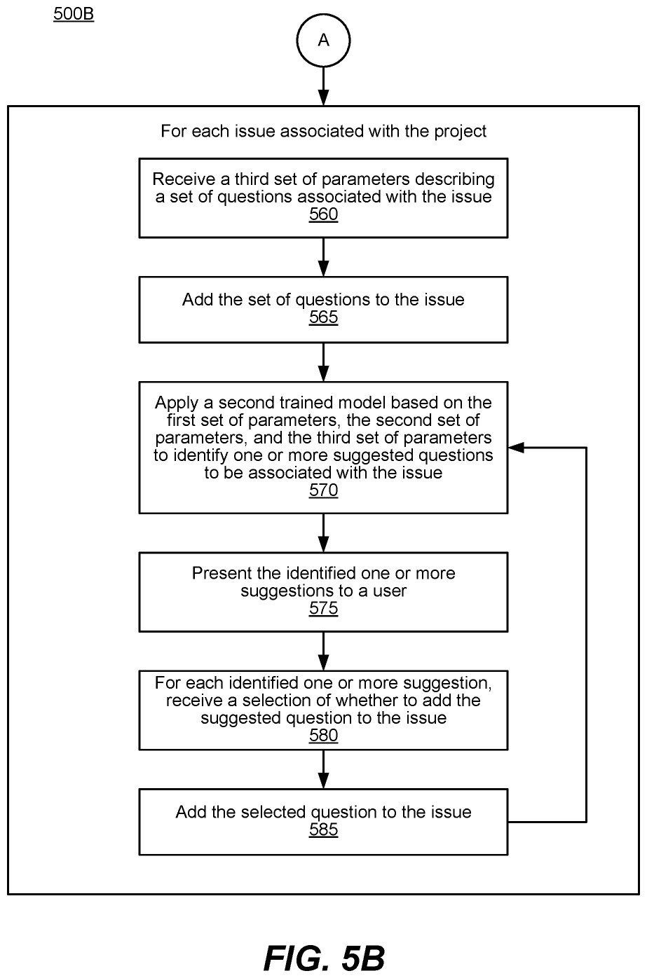

FIGS. 5A and 5B illustrate a process 500 for populating the schema of a project, according to one or more embodiments. In some embodiments, the steps shown in FIGS. 5A and 5B are performed by the recommendation system 240. Alternatively, one or more steps of the process 500 are performed by one or more other systems (such as the third party system 230 or a client device 210). It should be noted that in some embodiments, the process 500 illustrated in FIGS. 5A and 5B can include fewer, additional, or different steps than those described herein. Moreover, the steps of process 500 may be performed in a different order than the one shown in FIGS. 5A and 5B.

First, issues are added to the schema for the project. FIG. 5A illustrates steps 500A for adding issues to the schema for the project. The recommendation system receives 515 a second set of parameters describing a set of issues expected to be encountered during execution of the project (e.g., parameters of the second type). Based on the received second set of parameters, the processing module 315 populates the schema for the new project. For example, the processing module 315 adds 520 the set of issues to the schema for the project.

In some embodiments, the set of issues are provided by users assigned to the new project. The processing module 315 may present the set of issues to a project administrator for the project to allow the project administrator to accept or reject each of the issues in the set of issues. The processing module 315 then adds 520 to the schema for the project the issues accepted by the project administrator. In some embodiments, the processing module 315 aggregates multiple issues based on a similarity between the multiple issued. For example, if a first issue provided by a first user and a second issue provided by a second user correspond to the same issue, the processing module 315 aggregates the first issue and the second issue together before presenting the set of issues to the project administrator. In some embodiments, the processing module 315 ranks and sorts the set of issues before presenting the set of issues to the project administrator. In some embodiments, the processing module 315 determines a score for each issue and ranks or sorts the issues based on the determined score. The score may be determined using a trained scoring module. Moreover, the score may be determined based on a number of users that provided the same issue to the recommendation system 240.

In some embodiments, an issue sourcing period is run during which information (such as parameters of the second type) describing a set of issues is received from a set of users associated with the project. During the issue sourcing period, information received from each user is hidden from other users associated with the project. As such, during the issue sourcing period, each user is not presented with the issues that are being provided by other users associated with the project. In some embodiments, the issue sourcing period is set by the project administrator. That is, the project administrator may set the start, end, and/or duration of the issue sourcing period.

The recommendation system 240 applies 525 first trained model based on the schema for the project to identify one or more suggested issues that might be encountered during the execution of the project. For example, the recommendation system 240 applies 525 the issue recommendation model 320 based on the schema for the project. In some embodiments, the first set of parameters of the first type and the second set of parameters of the second type are provided to the issue recommendation model 320 to identify the one or more suggested issues. That is, the suggested issues are identified based on information about the project and information about issues associated with the project. Alternatively, a feature vector or an embedding vector is generated based on the first set of parameters of the first type and the second set of parameters of the second type, and provided to the issue recommendation model 330.

The identified one or more suggested issues are presented 530 to the project administrator. In some embodiments, the identified one or more suggested issues are sorted or ranked based on a score (e.g., a relevancy score). The project administrator may then accept or reject the suggested issues. The recommendation system 240 receives 535, for each suggested issues, a selection of whether to add the suggested issue to the schema for the project. Upon receiving an indication to add a suggested issue to the schema for the project, the processing module 315 automatically modifies the schema for the project to add 540 the suggested issue.

In some embodiments, the process loops back to step 525 to provide additional suggested issues to the project administrator. The process 500 may keep looping until the project administrator is satisfied with the issues added to the schema for the project.

After issues have been added to the schema for the project, questions are added for each issue included in the schema for the project. FIG. 5B illustrates steps 500B for adding questions to issues included in the schema for a project, according to one or more embodiments. For each issue, the recommendation system 240 receives 560 a third set of parameters describing a set of questions associated with the issue (e.g., parameters of the third type). Based on the received third set of parameters the processing module 315 populates the schema for the new project. For example, the processing module 315 adds 565 the set of questions to the schema for the project.

In some embodiments, the set of questions for a given issue are provided by users assigned to the issue. The processing module 315 may present the set of questions to the project administrator to allow the project administrator to accept or reject each of the questions in the set of questions. The processing module 315 then adds 565 to the schema for the project the questions accepted by the project administrator. In some embodiments, the processing module 315 aggregates multiple questions based on a similarity between the multiple questions. For example, if a first question provided by a first user and a second question provided by a second user correspond to the same question, the processing module 315 aggregates the first question and the second question together before presenting the set of questions to the project manager. In some embodiments, the processing module 315 ranks or sorts the set of questions before presenting the set of questions to the project manager. In some embodiments, the processing module 315 determines a score for each question and ranks or sorts the questions based on the determined score. The score may be determined using a trained scoring module. Moreover, the score may be determined based on a number of users that provided the same question to the recommendation system 240.

In some embodiments, a question sourcing period is run during which information (such as parameters of the third type) describing a set of questions is received from a set of users associated with the project or with an issue for which questions are being sourced. During the question sourcing period, information received from each user is hidden from other users associated with the project. As such, during the question sourcing period, each user is not presented with the questions that are being provided by other users associated with the project or issue. In some embodiments, the question sourcing period is set by the project administrator. That is, the project administrator may set the start, end, and/or duration of the question sourcing period.

The recommendation system 240 applies 570 a second trained model based on the schema for the project to identify one or more suggested questions for one or more issues associated with the project. For example, the recommendation system 240 applies 570 the question recommendation model 330 based on the schema for the project. In some embodiments, the first set of parameters of the first type, the second set of parameters of the second type, and the third set of parameters of the third type are provided to the question recommendation model 330 to identify the one or more suggested questions. That is, the suggested questions are identified based on information about the project, information about issues associated with the project, and questions associated with one or more issues of the project. Alternatively, a feature vector or an embedding vector is generated based on the first set of parameters of the first type, the second set of parameters of the second type, and the third set of parameters of the third type, and provided to the question recommendation model 330. In some embodiments a set of suggested questions is generated for each issue associated with the project.

The identified one or more suggested questions are presented 575 to the project administrator. In some embodiments, the identified one or more suggested questions are sorted or ranked based on a score (e.g., a relevancy score). The project administrator may then accept or reject the suggested questions. The recommendation system 240 receives 580, for each suggested question, a selection of whether to add the suggested question to the schema for the project. Upon receiving an indication to add a suggested question to the schema for the project, the processing module 315 automatically modifies the schema for the project to add 585 the suggested question.

In some embodiments, the process loops back to step 570 to provide additional suggested questions to the project manager. The process 500 may keep looping until the project administrator is satisfied with the questions added to each issue associated with the project.

In some embodiments, the process loops back to step 520 to suggest additional issues based on the questions provided to the recommendation system 240. The recommendation system 240 may apply the issue recommendation model 320 based on the modified schema (including the questions added to the schema).

### Schema Matching Based Recommendation Process

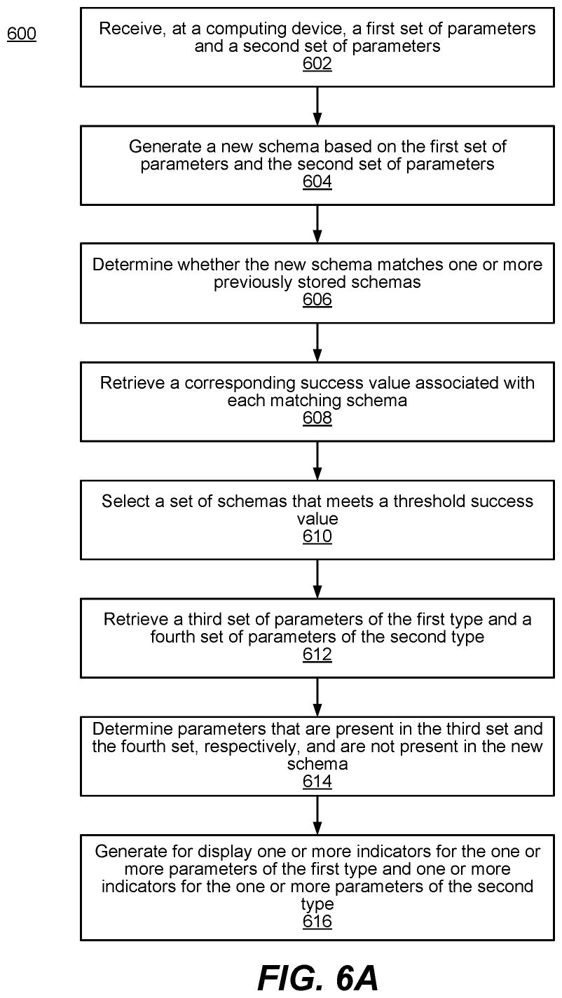

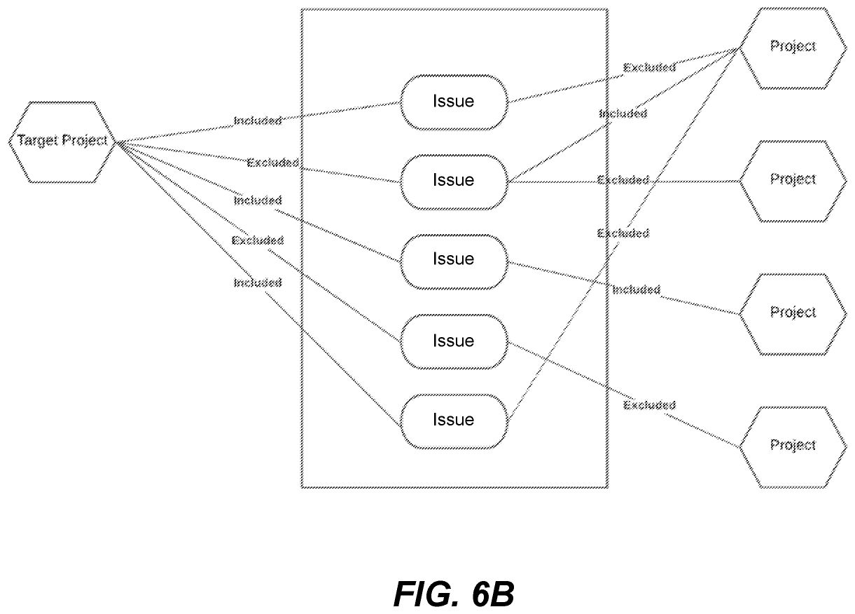

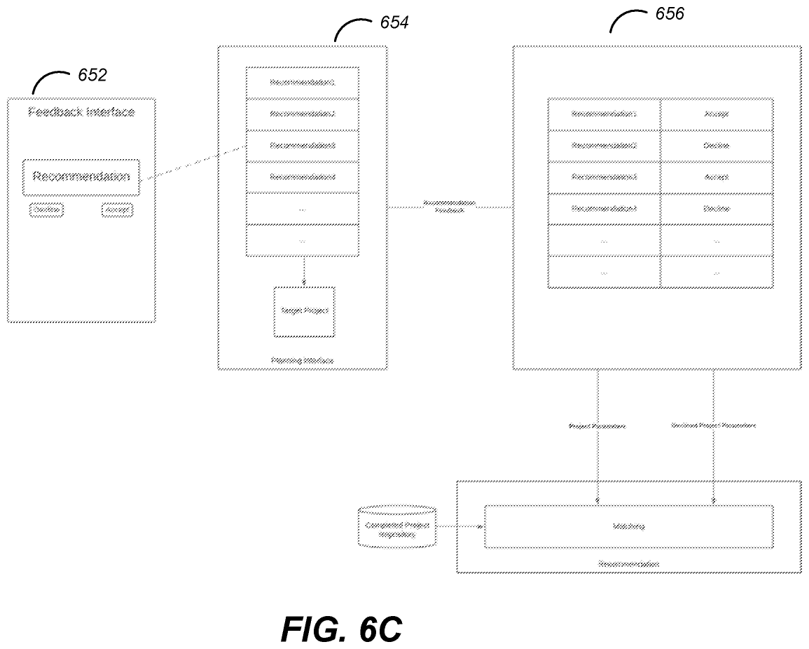

FIG. 6A illustrates a process for recommending parameters for a schema, according to one or more embodiments. The recommendation system 240 may receive 602 a first set of parameters and a second set of parameters. The first set of parameters may be of a first type (e.g., including information about a new project), and the second set of parameters may be of a second type (e.g., including information about one or more issues associated with the project. For example, the computing device may receive the parameters via alpha-numeric input device 712 and/or cursor control device 714. The parameters may be selected based on prompts generated using visual interface 710. In some embodiments, the parameters may be received using network interface device 720 via network 726.

The processing module 315 generates 604 a new schema based on the first set of parameters and the second set of parameters. For example, the parameters may be stored in the schema store 310. The processing module 315 may retrieve the parameters and generate a new data structure for the new schema. The processing module 315 may generate a data structure for each parameter and store the parameters in association with the new schema. The processing module 315 determines 606 whether the new schema matches one or more previously stored schemas. For example, processing module 315 may retrieve previously stored schemas from the schema store (e.g., implemented in main memory 704, storage unit 716, or from another computing device through network interface device 720 and received from network 726). The processing module 315 may also retrieve the new schema from these locations and perform a comparison operation (e.g., using an application programming interface).

In some embodiments, the processing module 315 determines whether the new schema for a target project matches one or more previously stored schemas by performing a nearest neighbor technique to find a set of projects or nearest neighbors that have included the same or similar parameters as the target project. The processing module 315 may compare the new schema (e.g., for the target project) with other schemas (e.g., for previously completed projects) based on the various parameter types included in the target schema. The below equation may be used to illustrate determining how similar two schemas are.

$$sim ( a , b ) = \frac{{Σ}_{p ∈ P} ( {r}_{a , p} - \overline{{r}_{a}} ) ( {r}_{b , p} - \overline{{r}_{b}} )}{\sqrt{{{Σ}_{p ∈ P} ( {r}_{a , p} - \overline{{r}_{a}} )}^{2}} \sqrt{{{Σ}_{p ∈ P} ( {r}_{b , p} - \overline{{r}_{b}} )}^{2}}}$$

where a and b are schemas (e.g., projects), r(a, p) is a rating of a schema a for parameter p, and P is the set of parameters rated for both schemas a and b. For example, a parameter included in the schema would receive a rating of 1 by that schema. A parameter excluded from a schema would receive a rating of 0 by that schema. Thus, the system may iterate through other schemas to identify one or more similar schemas. When the similar schemas are identified, the processing module 315 may select parameters from the one or more similar schemas that may be recommended for the project and/or may be automatically added to the project. The processing module 315 then predict a rating pred(a,p) if target schema a did not include/rate a parameter p. The below equation may be used for the prediction:

$$pred ( a , p ) = \overline{{r}_{a}} + \frac{{\sum }_{b ∈ N} sim ( a , b ) * ( {r}_{b , p} - \overline{{r}_{b}} )}{{\sum }_{b ∈ N} sim ( a , b )}$$

where a and b are schemas (e.g., projects) r(b, p) is a rating of a schema b for parameter p, N is the set of schemas similar to the target schema, r(b) is the average rating for schema b, and r(a) is the target schemas average rating.

In some embodiments, the processing module 315 retrieves 608 a corresponding success value associated with each matching schema. The processing module 315 then selects 610 a set of schemas that meets a threshold success value. For example, processing module 315 may retrieve (e.g., from main memory 704 and/or from storage unit 716) the threshold success value. The processing module 315 may compare the threshold success value with success values of the matching schemas.

The processing module 315 may retrieve 612 a third set of parameters of the first type and a fourth set of parameters of the second type associated with the matching schemas. For example, processor 702 may retrieve (e.g., from main memory 704 and/or from storage unit 716) parameters associated with the selected matching schemas

The processing module 315 may determine 614 parameters that are present in the third set and the fourth set, respectively, and are not present in the new schema. For example, the processing module 315 may compare the retrieved third set of parameters and the fourth set of parameters with respective parameter types of the new schema and determine which parameters are present and which are not. The processing module 315 then generates 616 for display one or more indicators for the one or more parameters of the first type and one or more indicators for the one or more parameters of the second type.

FIG. 6B illustrates one parameter type and possible ratings for various projects for parameters of that type, according to one or more embodiments. For example, recommendation system may aggregate the ratings from various projects and generate a rating for parameter (e.g., a particular issue or task). That rating may then be used to identify other similar parameters of that parameter type. The recommendation system may perform the same calculations for other parameters of other parameter types. A parameter may receive its rating from the inclusion/exclusion to a schema. For example, when a recommendation is accepted it is then included into a schema's parameter set and receives a rating of 1 from that schema. When a recommendation is declined explicitly or implicitly (e.g., a recommendation is not acted upon) it is then considered to be excluded from the schema's parameter set and receives a rating of 0 from that that schema.

FIG. 6C illustrates a recommendation interface that enables receiving and updating ratings for various parameters, according to one or more embodiments. The recommendation system 240 may generate for display a recommendation 652 and a prompt asking the user whether to accept or decline the recommendation. When the recommendation system receives the response to the prompt, the recommendation system may update ratings (e.g., in data structure 654) for the recommendation and may store the response in data structure 656. In some embodiments, the recommendation system may recommend parameters based on the rate of the parameter being accepted and rejected.

### Computing Machine Architecture

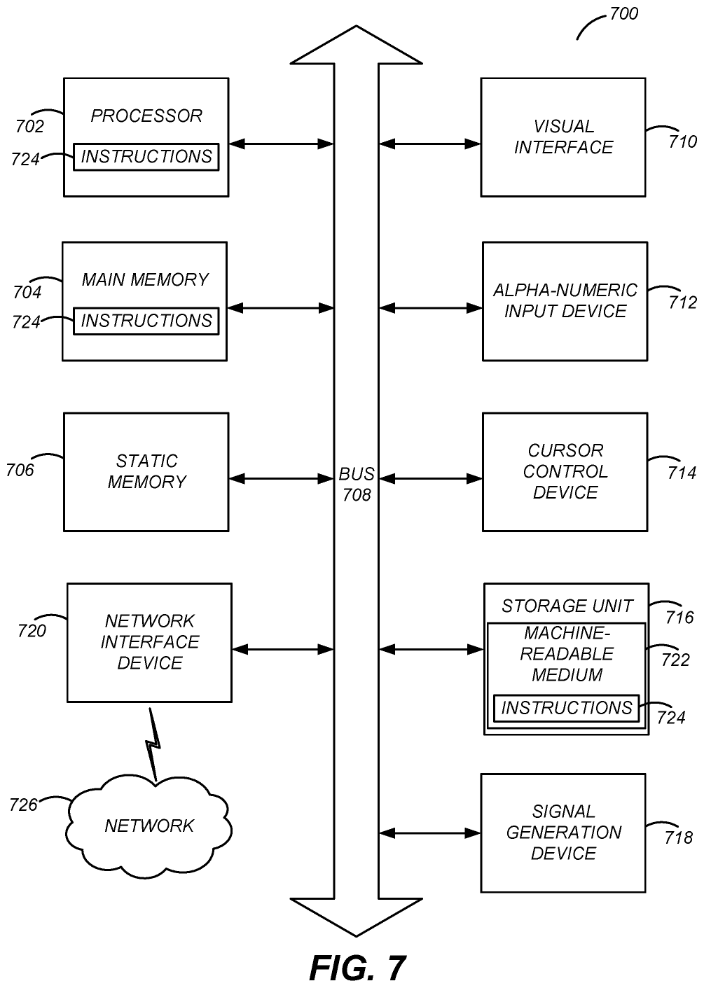

The actions described above may be hosted on one or more computing devices. FIG. 7 is a block diagram illustrating components of an example machine able to read instructions from a machine-readable medium and execute them in a processor (or controller). Specifically, FIG. 7 shows a diagrammatic representation of a machine in the example form of a computer system 700 within which program code (e.g., software) for causing the machine to perform any one or more of the methodologies discussed herein may be executed. The program code may be comprised of instructions 724 executable by one or more processors 702. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 724 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 700 includes a processor 702 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 704, and a static memory 706, which are configured to communicate with each other via a bus 708. The computer system 700 may further include visual display interface 710. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 710 may include or may interface with a touch enabled screen. The computer system 700 may also include alphanumeric input device 712 (e.g., a keyboard or touch screen keyboard), a cursor control device 714 (e.g., a mouse, a trackball, a joystick, a motion sensor, or other pointing instrument), a storage unit 716, a signal generation device 718 (e.g., a speaker), and a network interface device 720, which also are configured to communicate via the bus 708.

The storage unit 716 includes a machine-readable medium 722 on which is stored instructions 724 (e.g., software) embodying any one or more of the methodologies or functions described herein. The instructions 724 (e.g., software) may also reside, completely or at least partially, within the main memory 704 or within the processor 702 (e.g., within a processor's cache memory) during execution thereof by the computer system 700, the main memory 704 and the processor 702 also constituting machine-readable media. The instructions 724 (e.g., software) may be transmitted or received over a network 726 via the network interface device 720.

While machine-readable medium 722 is shown in an example embodiment to be a single medium, the term “machine-readable medium” should be taken to include a single medium or multiple media (e.g., a centralized or distributed database, or associated caches and servers) able to store instructions (e.g., instructions 724). The term “machine-readable medium” shall also be taken to include any medium that is capable of storing instructions (e.g., instructions 724) for execution by the machine and that cause the machine to perform any one or more of the methodologies disclosed herein. The term “machine-readable medium” includes, but not be limited to, data repositories in the form of solid-state memories, optical media, and magnetic media.

### Example User Interfaces and Flow

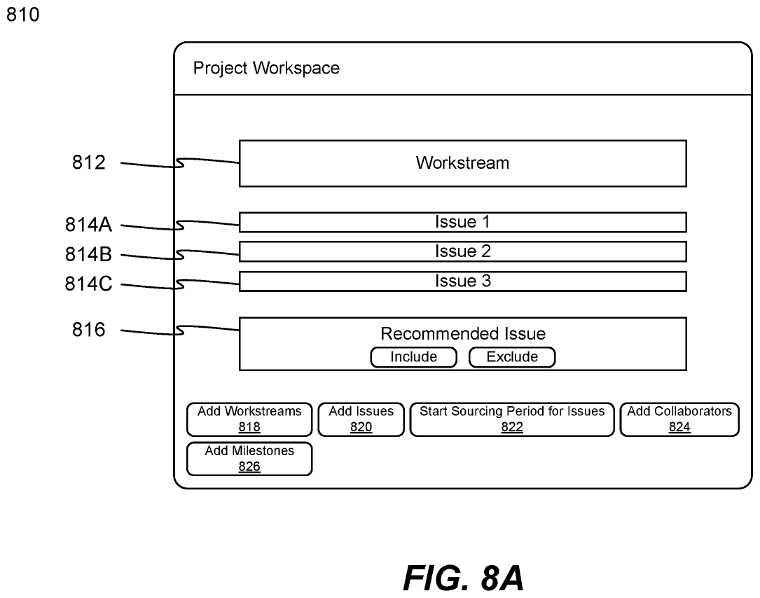

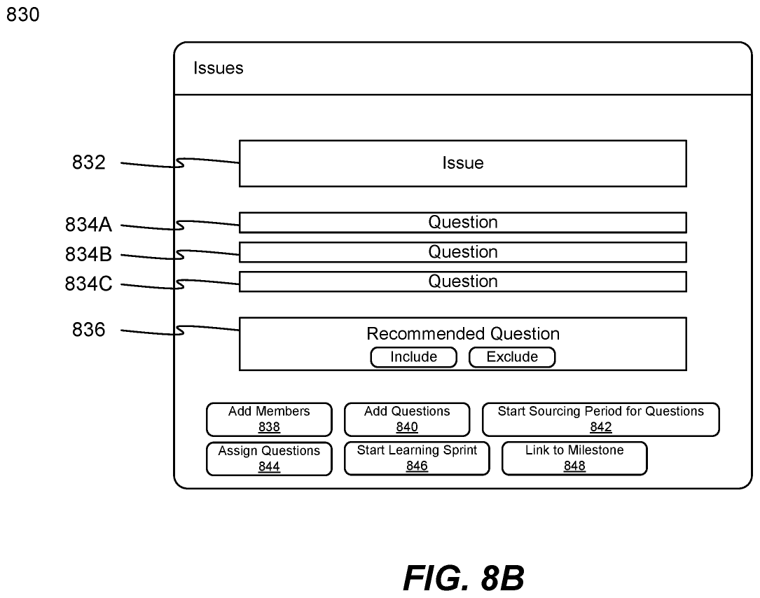

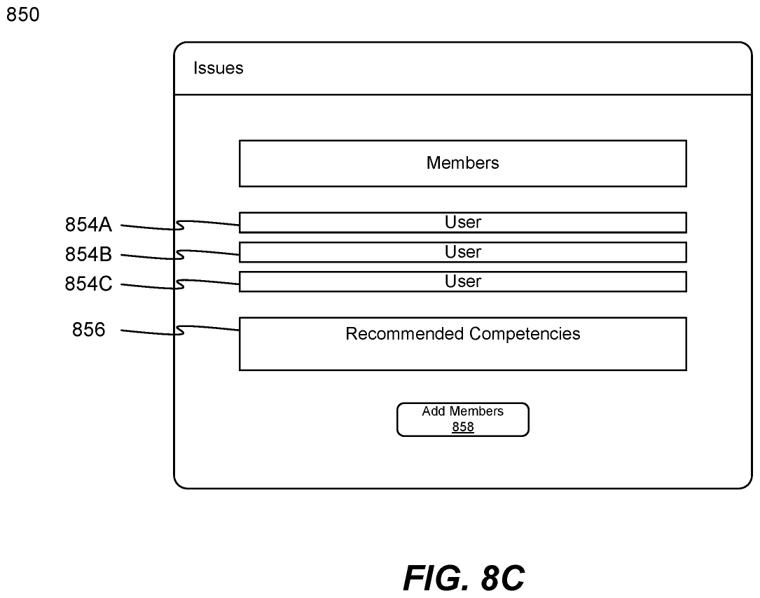

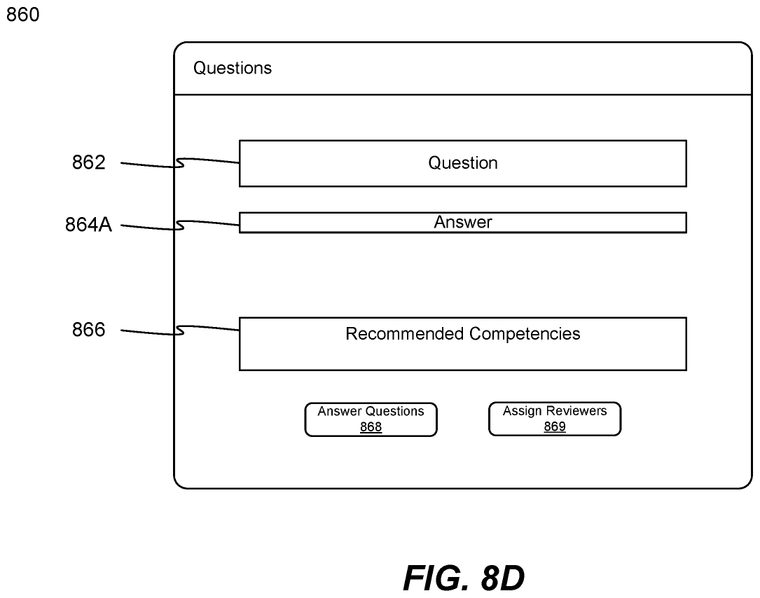

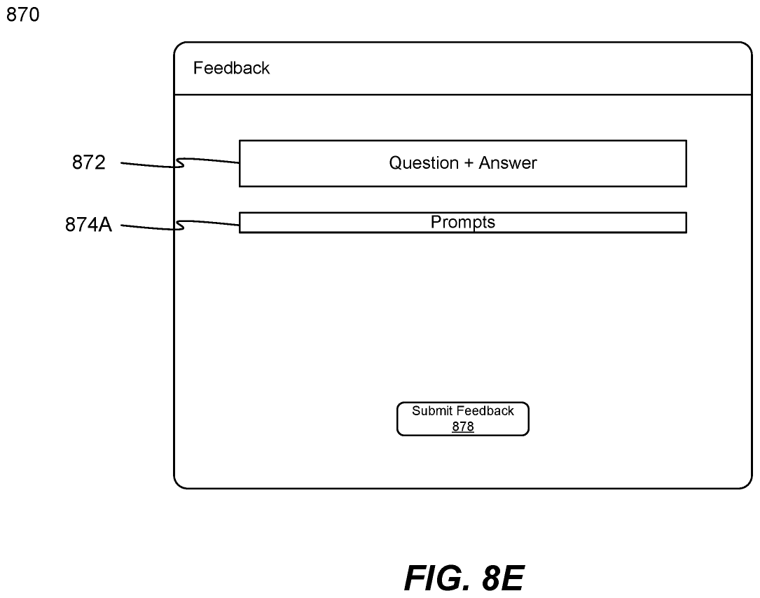

FIGS. 8A through 8E illustrate various user interfaces (UI) generated by the recommendation system and sent to client devices of users of the recommendation system, according to one or more embodiments. Some of the UIs are sent to project administrators of a project associated with a schema. Alternatively, other UIs are sent to other users assigned or associated with the project.

FIG. 8A illustrates a main user interface 810 for a project, according to one or more embodiments. The UI 810 includes a field 812 that provides details about a workstream or workflow of the project. For example, the UI 810 may display a name of the workstream. The UI 810 additionally includes one or more fields 814 displaying information about one or more issues associated with the project. For example, the UI 810 shown in FIG. 8A includes three fields 814A through 814C that shows information about three different issues. The issues shown in the UI 810 may be retrieved from the schema for the project. That is, the issues shown in the UI 810 correspond to issues that were added to the schema for the project (e.g., by the project administrator, or by another user assigned to the project and optionally accepted by the project administrator).

The UI 810 additionally includes one or more fields 816 displaying recommended issues. For example, the UI 810 of FIG. 8A illustrates a field 816 displaying information about one recommended issue. However, a UI may include additional fields showing information for multiple recommended issues. In some embodiments, the field 816 displaying information about one recommended issue includes buttons for accepting (including) or rejecting (excluding) the recommended issue. A project administrator may review the recommended issue and may instruct the recommendation system 240 to add the recommended issue to the schema for the project by interacting with the button for accepting the recommended issue. Upon receiving an indication that the project administrator has interacted with the button for accepting the recommended issues, the recommendation system 240 modifies the schema for the project to add the recommended issues.

In some embodiments, the displayed one or more recommended issues are selected based on an output of the issue recommendation model 320. For example, when dynamically generating the UI 810 to be provided to a user of the recommendation system 240, the recommendation system applies the issue recommendation model 320 based on the current schema for the project. The issue recommendation model 320 is executed based on the schema for the project and one or more recommended issues are selected based on the output of the issue recommendation model 320. In some embodiments, the recommendation system 240 further ranks, sorts, and/or filters the recommended issues selected based on the output of the issue recommendation model 320 and dynamically generates the UI 810 to include the selected recommended issues.

In some embodiments, the UI 810 includes one or more buttons (e.g., buttons 818 through 826) for instructing the recommendation system 240 to perform one or more operations. For example, the UI 810 includes an add workstreams button 818 for instructing the recommendation system 240 to add a new workstream or a workflow to the schema for the project. Moreover, the UI 810 includes an add issues button 820 for instructing the recommendation system 240 to add a new issue to the schema for the project. The UI 810 further includes a start sourcing period for issues button 822 for instructing the recommendation system 240 to initiate a sourcing period for the current workstream. The UI 810 additionally includes an add collaborators button 824 for instructing the recommendation system 240 to add or assign a new user (collaborator) to the workstream, and an add milestones button 826 for instructing the recommendation system 240 to add a new milestone to the schema for the project.

In some embodiments, the start sourcing period for issues button 822 instructs the recommendation system 240 to initiate a sourcing period for the current workstream. Upon receiving an indication that a project administrator has selected the start sourcing period for issues button 822, the recommendation system sends requests to users associated with the project or workstream (e.g., collaborators assigned to the project or workstream) to provide issues for the workstream. That is, the recommendation system 240 sends requests to users associated with the project or workstream to provide parameters of the second type back to the recommendation system. In some embodiments, the recommendation system 240 generates user interfaces for each of the users associated with the workstream including specific fields for providing the parameters of the second type corresponding to one or more issues to be added to the workstream.

In some embodiments, during the sourcing period, issues are collected independently from each of the users associated with the workstream. During the sourcing period, users are not presented with issues that were provided by other users. Moreover, at the end of the sourcing period, the recommendation system 240 generates a UI (such UI 810 of FIG. 8A) to present the issues provided by each of the users associated with the workstream during the sourcing period to the project administrator. Using the UI presented to the project administrator, the project administrator may normalize, modify, or curate the various issues provided by the users assigned to the workstream. In some embodiments, before the start of a sourcing period, the recommendation system 240 prompts the project administrator to provide a set of settings for the sourcing period (e.g., a length of time or duration for the sourcing period).

In some embodiments, after the sourcing period ends, the recommendation system 240 may present the issues provided by each of the users to every user assigned to the workstream. In some embodiments, based on the issues provided by other users, users assigned to the workstream may be allowed to provide additional issues. Moreover, in some embodiments, as more issues are added to the schema of a project, the recommendation system may keep identifying additional recommended issues and may keep presenting the selected recommended issues to the project administrator. For example, each time the user interface (such as UI 810) corresponding to a workstream is open by the project administrator, the recommendation system 240 may identify one or more recommended issues based on the schema for the project at the time a request for the user interface is received by the recommendation system. In some embodiments, the recommendation system 240 may first determine whether to provide a recommended issue to the project administrator. For example, the recommendation system 240 may identify whether the schema for the project has changed since the last time recommended issues were presented to the project administrator, whether the project administrator has rejected a threshold number of recommended issues, whether any recommended issues has a relevance score higher than a threshold value, and the like.

FIG. 8B illustrates a user interface 830 corresponding to an issue associated with a project, according to one or more embodiments. In some embodiments, the UI 830 corresponding to an issue associated with the project may be accessed by interacting with a user interface element (such as field 814) corresponding to the issue in the UI 810 of FIG. 8A.

The UI 830 includes a field 832 that provides details about an issue. For example, the UI 830 may display a name of the issue. The UI 830 additionally includes one or more fields 834 displaying information about one or more questions associated with the issue. For example, the UI 830 shown in FIG. 8B includes three fields 834A through 834C that shows information about three different questions. The questions shown in the UI 830 may be retrieved from the schema for the project. That is, the questions shown in the UI 830 correspond to questions that were added to the schema for the project (e.g., by the project administrator, or by another user assigned to the project and optionally accepted by the project administrator).

The UI 830 additionally includes one or more fields 836 displaying recommended questions. For example, the UI 830 of FIG. 8B illustrates a field 836 displaying information about one recommended question. However, a UI may include additional fields showing information for multiple recommended questions. In some embodiments, the field 836 displaying information about one recommended question includes buttons for accepting (including) or rejecting (excluding) the recommended question. A project administrator may review the recommended question and may instruct the recommendation system 240 to add the recommended question to the schema for the project by interacting with the button for accepting the recommended question. Upon receiving an indication that the project administrator has interacted with the button for accepting the recommended question, the recommendation system 240 modifies the schema for the project to add the recommended question.

In some embodiments, the displayed one or more recommended questions are selected based on an output of the question recommendation model 330. For example, when dynamically generating the UI 830 to be provided to a user of the recommendation system 240, the recommendation system applies the question recommendation model 330 based on the current schema for the project. The question recommendation model 330 is executed based on the schema for the project and one or more recommended questions are selected based on the output of the question recommendation model 330. In some embodiments, the recommendation system 240 further ranks, sorts, and/or filters the recommended questions selected based on the output of the question recommendation model 330 and dynamically generates the UI 830 to include the selected recommended questions.

In some embodiments, the UI 830 includes one or more buttons (e.g., buttons 838 through 848) for instructing the recommendation system 240 to perform one or more operations. For example, the UI 830 includes an add members button 838 for instructing the recommendation system 240 to assign a new user to the issue (e.g., by modifying the schema for the project to associate the user with the issue). Moreover, the UI 830 includes an add questions button 840 for instructing the recommendation system 240 to add a new question to the schema for the project. The UI 830 further includes a start sourcing period for questions button 842 for instructing the recommendation system 240 to initiate a sourcing period for questions for the current issue. The UI 830 additionally includes an assign questions button 844 for instructing the recommendation system 240 to one or more questions to a user associated with the issues. The UI 830 includes a start learning sprint button 846 to initiate a sourcing period for answers to the questions associated with the issue. Finally, the UI 848 includes a link to milestone button 848 to associate the current issue to a milestone of the project.

In some embodiments, the start sourcing period for questions button 842 instructs the recommendation system 240 to initiate a sourcing period for questions to be associated with the current issue. Upon receiving an indication that a project administrator has selected the start sourcing period for questions button 842, the recommendation system sends requests to users associated with the issue (e.g., members assigned to the issue) to provide questions for the issue. That is, the recommendation system 240 sends requests to users associated with the issue to provide parameters of the third type back to the recommendation system. In some embodiments, the recommendation system 240 generates user interfaces for each of the users associated with the issue including specific fields for providing the parameters of the third type corresponding to one or more questions to be added to the workstream.

In some embodiments, during the sourcing period, questions are collected independently from each of the users associated with the issue. During the sourcing period, users are not presented with questions that were provided by other users. That is, during the sourcing period, inputs (such as parameters of the second type) provided by other users are hidden from each of the users. Moreover, at the end of the sourcing period, the recommendation system 240 generates a UI (such UI 830 of FIG. 8B) to present the questions provided by each of the users associated with the issue during the sourcing period to the project administrator. Using the UI presented to the project administrator, the project administrator may normalize, modify, or curate the various questions provided by the users assigned to the issue. In some embodiments, before the start of a sourcing period, the recommendation system 240 prompts the project administrator to provide a set of settings for the sourcing period (e.g., a length of time or duration for the sourcing period).

In some embodiments, after the sourcing period ends, the recommendation system 240 may present the questions provided by each of the users to every user assigned to the issue. In some embodiments, based on the questions provided by other users, users assigned to the issue may be allowed to provide additional questions.

In some embodiments, the start leaning spring button 846 is enabled after the sourcing period for questions for the current issue has ended. During the learning spring, users assigned to questions associated with the issue are prompted to provide answers to their assigned questions. For example, for each question associated with the issue, the recommendation system 240 identifies a set of users assigned to the question and prompts the set of users to provide answers for the question. In some embodiments, during the learning spring, users are now shown the answers provided by other users. In some embodiments, before the start of the learning sprint, the recommendation system 240 may prompt the project administrator to provide setting for the learning spring (such as a duration of the learning sprint). After the learning sprint concludes (i.e., after answers were gathered for each of the questions associated with the issue), the project administrator is presented with one or more user interfaces presenting the answers provided by the users during the learning sprint. In some embodiments, a separate user interface showing answers is generated for each question. In some embodiments, a separate learning sprint may be set for each issue.

FIG. 8C illustrates a user interface 850 for adding members to an issue, according to one or more embodiments. In some embodiments, the UI 850 may be accessed by interacting with the add members button 838 of UI 830 of FIG. 8B.

The UI 850 includes one or more fields 854 displaying information about one or more uses associated with the issue. For example, the UI 850 shown in FIG. 8C includes three fields 854A through 854C that shows information about three different users. The users shown in the UI 850 may be retrieved from the schema for the project.

The UI 850 additionally includes one or more fields 856 displaying recommended competencies. For example, the UI 850 of FIG. 8C illustrates a field 856 displaying information about one recommended competency. However, a UI may include additional fields showing information for multiple recommended competencies. A project administrator may review the recommended competencies and may instruct the recommendation system 240 to add one or more users to the issue (e.g., by interacting with the add members button 858). In some embodiments, the recommended competencies are identified by applying a trained competency recommendation model trained using past projects.

The UI 850 additionally includes an add members button 858. When the project administrator interacts with the add members button 858, the recommendation system 240 receives an indication to add a user to the issue. Based on information included in the request (such as an identification of the user to be added to the issue, or an identification of the issue), the recommendation system modifies the schema for the project to add the user to the issue.

FIG. 8D illustrates a user interface 860 corresponding to a question associated with an issue of a project, according to one or more embodiments. In some embodiments, the UI 860 corresponding to a question may be accessed by interacting with a user interface element (such as field 834) of FIG. 8B.

The UI 860 includes a field 862 that provides details about a question. For example, the UI 830 may display a string corresponding to the question being asked. The UI 860 additionally includes one or more fields 864 displaying information about one or more answers for the question. For example, the UI 860 shown in FIG. 8D includes one fields 834A that shows information about one answer (e.g., provided by a member associated with the question). The answers shown in the UI 860 may be retrieved from the schema for the project. That is, the answers shown in the UI 860 correspond to answers that were added to the schema for the project (e.g., by the project administrator, or by another user assigned to the project and optionally accepted by the project administrator).

The UI 860 additionally includes one or more fields 866 displaying recommended competencies. For example, the UI 860 of FIG. 8D illustrates a field 866 displaying information about one recommended competency. However, a UI may include additional fields showing information for multiple recommended competencies. In some embodiments, the recommended competencies displayed in the one or more fields 866 correspond to the recommended competencies for selecting one or more users to review the answers provided for the question. In some embodiments, a project administrator may review the recommended competencies and may instruct the recommendation system 240 to assign one or more reviewers to the questions (e.g., by interacting with the assign reviewers button 869). Alternatively, users providing answers for the question may be allowed to assign reviewers for the question or answers. The users providing the answers for a question may be presented with the recommended competencies and may instruct the recommendation system 240 (e.g., via assign reviewers button 869) to assign one or more reviewers for the question. In some embodiments, the recommended competencies are identified by applying a trained competency recommendation model trained using past projects.

The UI 860 additionally includes an answer questions button 868 for providing one or more answers to the question, and an assign reviewers 869 button for adding one or more reviewers for the question. In some embodiments, each of the answer questions button 868 and assign reviewers button 869 sends a request to the recommendation system to generate a corresponding user interface to allow a user to answer a question or to assign a new reviewer for the question accordingly.

FIG. 8E illustrates a user interface 870 for providing feedback about a question-answer pair, according to one or more embodiments. In some embodiments, the user interface 870 is generated for one or more question-answer pairs upon the triggering of a milestone. That is, when the recommendation system 240 determines that a milestone has reached, the recommendation system 240 displays the feedback user interface 870 to one or more users (such as the project administrator) to receive feedback about the quality and helpfulness of the question-answer pair.

The user interface 870 includes a field 872 for displaying information about the question-answer pair. For example, the field 872 displays strings corresponding to the question and the answer for the question-answer pair. The user interface 872 additionally includes a set of fields 874 displaying one or more prompts. For example, the prompts may instruct a user to answer one or more questions related to the question-answer pair. The prompts may ask the user to provide information about the quality, complexity and helpfulness of the question, and quality, complexity and helpfulness of the answer.

Moreover, the user interface 870 includes a submit feedback button 878 for sending the information entered in the feedback user interface 870 to the recommendation system 240. In some embodiments, the schema for the project is modified based on the received feedback. Moreover, in some embodiments, one or more models (such as the issue recommendation mode, the question recommendation model, or the competency recommendation model) are retrained based on the received feedback.

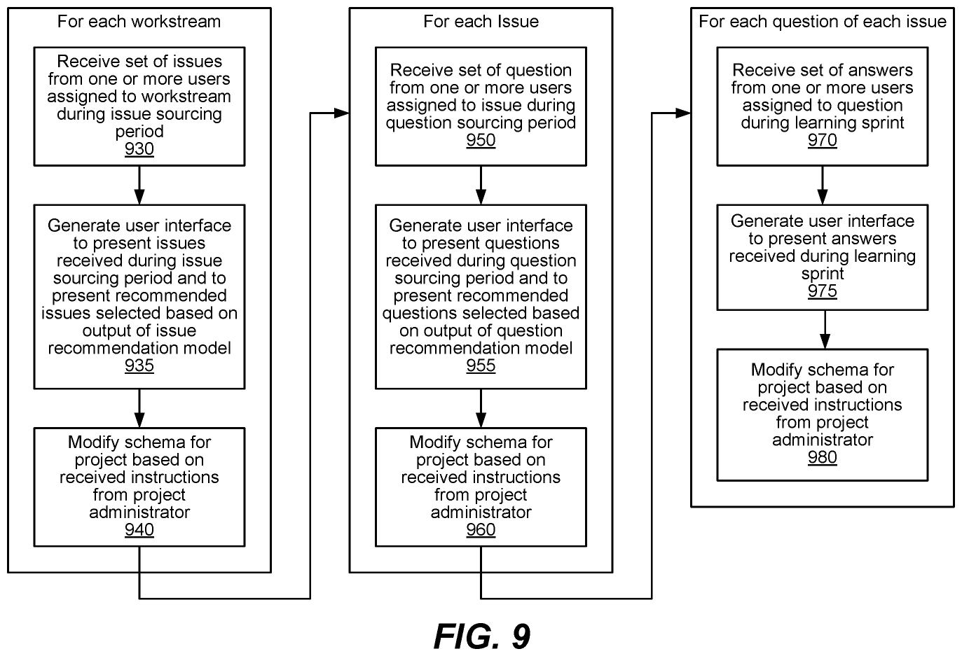

FIG. 9 illustrates a flow diagram of a process for providing parameters to update a schema for a project, according to one or more embodiments. It should be noted that in some embodiments, the process 900 illustrated in FIG. 9 can include fewer, additional, or different steps than those described herein. Moreover, the steps of process 900 may be performed in a different order than the one shown in FIG. 9.

The recommendation system 240 receives 930, for each workstream or workflow, a set of issues from one or more users assigned to the workstream during an issue sourcing period. In some embodiments, each workstream has a separate issue sourcing period. Moreover, the project administrator may initiate the sourcing period for each workstream using the start sourcing period for issues button 822 of FIG. 8A.

During a sourcing period for a workstream, each user assigned to a workstream is allowed to provide information about one or more issues (i.e., parameters of the second type) related to the workstream. Moreover, during the sourcing period, the users assigned to the workstream are not provided information about issues that were provided to the recommendation system 240 by other users assigned to the same workstream.

At the end of the sourcing period for the workstream, the recommendation model generates 935 and sends a user interface (such as user interface 810 of FIG. 8A) to a project manager to present information about the issues received from the one or more users assigned to the workstream during the sourcing period. Moreover, the user interface includes one or more recommended issues selected based on the schema for the project.

The project administrator may review the issues provided by each of the users assigned to the workstream and the one or more recommended issues, and may instruct the recommendation system 240 to add one or more issues to the schema for the project (e.g., one or more issues provided by users assigned to the workstream and/or one or more recommended issues selected based on an output of the issue recommendation model). In some embodiments, the issues are also liked to one or more milestones for the project. Based on the instructions received from the client device of the project administrator, the recommendation system 240 modifies 940 the schema for the project.

Moreover, after one or more issues have been added to a workstream, the recommendation system receives 950 a set of questions for the issue from one or more users assigned to the issue during a question sourcing period. In some embodiments, each issue has a separate question sourcing period. Moreover, the project administrator may initiate the question sourcing period for each issue using the start sourcing period for questions button 842 of FIG. 8B.

During a sourcing period for an issue, each user assigned to a workspace or workstream is allowed to provide information about one or more questions (i.e., parameters of the third type) related to the issue. Moreover, during the sourcing period, the users assigned to the issue are not provided information about questions that were provided to the recommendation system 240 by other users assigned to the same issue.

At the end of the sourcing period for the issue, the recommendation model generates 955 and sends a user interface (such as user interface 830 of FIG. 8B) to a project manager to present information about the questions received from the one or more users assigned to the issue during the sourcing period. Moreover, the user interface includes one or more recommended questions selected based on the schema for the project.

The project administrator may review the questions provided by each of the users assigned to the issue and the one or more recommended questions, and may instruct the recommendation system 240 to add one or more questions to the schema for the project (e.g., one or more questions provided by users assigned to the workstream and/or one or more recommended questions selected based on an output of the question recommendation model). Based on the instructions received from the client device of the project administrator, the recommendation system 240 modifies 960 the schema for the project.

Moreover, after one or more questions have been added for an issue, the recommendation system receives 970 a set of answers each of the questions from one or more users assigned to the questions during a learning sprint period. In some embodiments, each question has a separate learning sprint period. Moreover, the project administrator may initiate the learning sprint period for each question using the start learning sprint button 846 of FIG. 8B.

During a learning sprint for a question, each user assigned to a question is allowed to provide answers for one or more questions (i.e., parameters of the fourth type). Moreover, during the learning sprint period, the users assigned to the question are not provided information about answers that were provided to the recommendation system 240 by other users assigned to the same question. In some embodiments, during the learning spring a user providing an answer for a question is additionally allowed to identify one or more users to be assigned as reviewers for the answer. In some embodiments, the user providing an answer for a question is presented with a set of recommended competencies for the reviewer of the answer. Based on the recommended competencies, the user providing the answer may select one or more users to be assigned as the reviewers for the answer.

As answers are received from users assigned to one or more questions, the recommendation model generates 975 and sends a user interface (such as user interface 860 of FIG. 8D) to a project manager or an assigned reviewer to present information about the answers received from the one or more users assigned to the question.

The project administrator or an assigned reviewer may review the answers provided by each of the users assigned to the question and may instruct the recommendation system 240 to add one or more answers to the schema for the project. Based on the instructions received from the client device of the project administrator, the recommendation system 240 modifies 980 the schema for the project. Alternatively, the project administrator or assigned reviewer may reject the answer, provide comments on the answer, ask for a revision to the answer, or the like. In some embodiments, if no answers are accepted for a question, the question may be sent back to users assigned to the question to provide additional answers or to revise the answers that were previously provided for the question.

### Additional Configuration Considerations

The disclosed process advantageously uses trained models to provide recommendations on for the planning stage of a project to increase the likelihood of success for the project. The recommendation system leverages information gathered about past projects and feedback received from users associated with past projects to train the various models (such as the issue recommendation model and the question recommendation model) to improve the recommendations provided for a new project. As the number of projects used by the recommendation process for training the various models increases, the quality of the recommendations and the helpfulness of the recommendations also increases.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present)

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for automatically generating parameters to be added to a schema or recommending those parameters through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for recommending parameters for a target schema, comprising:
receiving, at a computing device, a first set of parameters of a first type, the first set of parameters describing a project;
generating a new schema for the project based on the first set of parameters;
receiving a second set of parameters of a second type, the second set of parameters describing a set of issues associated with the project;
applying a first trained model based on the schema for the project to identify a set of suggested issues for the project;
receiving a first indication accepting one or more suggested issues of the set of suggested issues;
modifying automatically the schema for the project to add parameters of the second type corresponding to the accepted one or more suggested issues;
receiving a third set of parameters of a third type, the third set of parameters describing one or more questions associated with each issue associated with the project;
applying a second trained model based on the modified schema for the project to identify a set of suggested questions for one or more issues associated with the project;
receiving a second indication accepting one or more suggested questions of the set of suggested questions; and
modifying automatically the schema for the project to add parameters of the third type corresponding to the accepted one or more suggested questions.

2. The method of claim 1, wherein the first trained model and the second trained model are trained using a training set including a plurality of past project.

3. The method of claim 2, wherein the first trained model and the second trained model are trained based on embedding vectors for each past project of the plurality of past project, and an indication of whether the past project was successfully completed.

4. The method of claim 3, wherein the embedding vector for each project is determined by determining a parameter embedding vector for each parameter of the first type included in the schema for the project, each parameter of the second type included in the project, and each parameter of the third type included in the project, and combining the parameter embedding vectors.

5. The method of claim 1, wherein the second set of parameters of the second type are received from a plurality of users associated with the project, and wherein the method further comprises:
presenting the second set of parameters of the second type to a project administrator;
for each parameter of the second set of parameters of the second type:
receiving an indication whether to accept or reject the parameter, and
responsive to receiving an indication to accept the parameter, modifying the schema for the project to add the parameter of the second type; and
wherein the first trained model is applied based at least on the first set of parameters of the first type and the accepted parameters from the second set of parameters of the second type.

6. The method of claim 5, wherein presenting the second set of parameters to the project manager comprises:
determining a relevancy score for each parameter of the second set of parameters, the relevancy score determined at least based on one of an output of a trained relevancy model applied based information associated with the parameter, and a number of users that provided parameters corresponding to a same issue as the parameter.

7. The method of claim 1, wherein the third set of parameters of the third type are received from a plurality of users associated with the project, and wherein the method further comprises:
presenting the third set of parameters of the third type to a project administrator;
for each parameter of the third set of parameters of the third type:
receiving an indication whether to accept or reject the parameter, and
responsive to receiving an indication to accept the parameter, modifying the schema for the project to add the parameter of the third type; and
wherein the second trained model is applied based at least on the first set of parameters of the first type, a subset of the second set of parameters of the second type, and the accepted parameters from the third set of parameters of the third type.

8. The method of claim 1, wherein applying the first trained model comprises:
generating a project embedding vector for the schema based at least in part on the first set of parameters of the first type and a subset of the second set of parameters of the second type; and
applying the first trained model based on the determined project embedding vector.

9. The method of claim 1, wherein applying the second trained model comprises:
generating a project embedding vector for the schema based at least in part on the first set of parameters of the first type, a subset of the second set of parameters of the second type, and a subset of the third set of parameters of the third type; and
applying the second trained model based on the determined project embedding vector.

10. A non-transitory computer readable storage medium comprising stored instructions for recommending parameters for a target schema, the instructions when executed by a processor cause the processor to:
receive, at a computing device, a first set of parameters of a first type, the first set of parameters describing a project;
generate a new schema for the project based on the first set of parameters;
receive a second set of parameters of a second type, the second set of parameters describing a set of issues associated with the project;
apply a first trained model based on the schema for the project to identify a set of suggested issues for the project;
receive a first indication accepting one or more suggested issues of the set of suggested issues;
modify automatically the schema for the project to add parameters of the second type corresponding to the accepted one or more suggested issues;
receive a third set of parameters of a third type, the third set of parameters describing one or more questions associated with each issue associated with the project;
apply a second trained model based on the modified schema for the project to identify a set of suggested questions for one or more issues associated with the project;
receive a second indication accepting one or more suggested questions of the set of suggested questions; and
modify automatically the schema for the project to add parameters of the third type corresponding to the accepted one or more suggested questions.

11. The non-transitory computer readable storage medium of claim 10, wherein the first trained model and the second trained model are trained using a training set including a plurality of past project.

12. The non-transitory computer readable storage medium of claim 11, wherein the first trained model and the second trained model are trained based on embedding vectors for each past project of the plurality of past project, and an indication of whether the past project was successfully completed.

13. The non-transitory computer readable storage medium of claim 12, further comprising stored instructions that when executed by a processor causes the processor to determine the embedding vector for each project by determining a parameter embedding vector for each parameter of the first type included in the schema for the project, each parameter of the second type included in the project, and each parameter of the third type included in the project, and combining the parameter embedding vectors.

14. The non-transitory computer readable storage medium of claim 10, wherein the second set of parameters of the second type are received from a plurality of users associated with the project, and wherein the instructions further comprise instructions that when executed by the processor causes the processor to:
present the second set of parameters of the second type to a project administrator;
for each parameter of the second set of parameters of the second type:
receive an indication whether to accept or reject the parameter, and
responsive to receiving an indication to accept the parameter, modify the schema for the project to add the parameter of the second type; and
wherein the first trained model is applied based at least on the first set of parameters of the first type and the accepted parameters from the second set of parameters of the second type.

15. The non-transitory computer readable storage medium of claim 14, wherein the instructions to present the second set of parameters to the project manager further comprised instructions that when executed causes the processor to:
determine a relevancy score for each parameter of the second set of parameters, the relevancy score determined at least based on one of an output of a trained relevancy model applied based information associated with the parameter, and a number of users that provided parameters corresponding to a same issue as the parameter.

16. The non-transitory computer readable storage medium of claim 10, wherein the third set of parameters of the third type are received from a plurality of users associated with the project, and wherein the instructions further comprise instructions that when executed causes the processor to:
present the third set of parameters of the third type to a project administrator;
for each parameter of the third set of parameters of the third type:
receive an indication whether to accept or reject the parameter, and
responsive to receiving an indication to accept the parameter, modify the schema for the project to add the parameter of the third type; and
wherein the second trained model is applied based at least on the first set of parameters of the first type, a subset of the second set of parameters of the second type, and the accepted parameters from the third set of parameters of the third type.

17. The non-transitory computer readable storage medium of claim 10, wherein the instructions to apply the first trained model further comprises instructions that when executed causes the processor to:
generate a project embedding vector for the schema based at least in part on the first set of parameters of the first type and a subset of the second set of parameters of the second type; and
apply the first trained model based on the determined project embedding vector.

18. The non-transitory computer readable storage medium of claim 10, wherein the instruction to apply the second trained model further comprises instructions that when executed cause the processor to:
generate a project embedding vector for the schema based at least in part on the first set of parameters of the first type, a subset of the second set of parameters of the second type, and a subset of the third set of parameters of the third type; and
apply the second trained model based on the determined project embedding vector.

19. A system comprising:
a processor; and
a non-transitory computer readable storage medium storing instruction for recommending parameters for a target schema, the instruction when executed by the processor cause the processor to:
receive, at a computing device, a first set of parameters of a first type, the first set of parameters describing a project;
generate a new schema for the project based on the first set of parameters;
receive a second set of parameters of a second type, the second set of parameters describing a set of issues associated with the project;
apply a first trained model based on the schema for the project to identify a set of suggested issues for the project;
receive a first indication accepting one or more suggested issues of the set of suggested issues;
modify automatically the schema for the project to add parameters of the second type corresponding to the accepted one or more suggested issues;
receive a third set of parameters of a third type, the third set of parameters describing one or more questions associated with each issue associated with the project;
apply a second trained model based on the modified schema for the project to identify a set of suggested questions for one or more issues associated with the project;
receive a second indication accepting one or more suggested questions of the set of suggested questions; and
modify automatically the schema for the project to add parameters of the third type corresponding to the accepted one or more suggested questions.

20. The system of claim 19, wherein the first trained model and the second trained model are trained using a training set including a plurality of past project.
